(19) United States
(12) Patent Application Publication
(10) Pub. No.: US 2013/0342505 A1
(43) Pub. Date: Dec. 26, 2013

(54) INPUT UNIT, ELECTRONIC DEVICE, AND MOBILE TERMINAL

(71) Applicants: Yoshio Miyazaki, Kirishima-shi (JP); Takashi Shimizu, Kirishima-shi (JP); Takashi Minami, Kirishima-shi (JP)

(72) Inventors: Yoshio Miyazaki, Kirishima-shi (JP); Takashi Shimizu, Kirishima-shi (JP); Takashi Minami, Kirishima-shi (JP)

(73) Assignee: Kyocera Corporation, Kyoto (JP)

(21) Appl. No.: 14/003,659

(22) PCT Filed: Mar. 6, 2012
(86) PCT No.: PCT/JP2012/055678

§ 371 Date: Sep. 6, 2013

(30) Foreign Application Priority Data
Mar. 16, 2011 (JP) 2011-058135

(51) Int. Cl. G06F 3/044

(52) U.S. Cl. CPC G06F 3/044
USPC 345/174

(57) ABSTRACT

An input unit disposed opposite to a display unit having a plurality of pixel areas arranged in a matrix, includes: a substrate; a first detecting electrode pattern provided on the substrate; a second detecting electrode pattern provided on the substrate; and an insulator provided at a portion corresponding to an intersecting portion where the first detecting electrode pattern and second detecting electrode pattern intersect, wherein the insulator has a profile extending in a direction different from arrangement directions of the pixel area as viewed from above.

### FIELD

The present invention relates to an input unit, an electronic device, and a mobile terminal.

### BACKGROUND

There is known, as an input unit, an electrostatic capacitance touch panel that detects an input position by detecting a change in electrostatic capacitance between, e.g., a finger and a detecting electrode (see, for example, Patent Literature 1).

Such an input unit is disposed opposite to, e.g., a display unit. The display unit has a plurality of pixel areas arranged in matrix. The input unit includes a substrate, a first detecting electrode pattern provided on the substrate, a second detecting electrode pattern provided on the substrate, and an insulator provided on a part of the substrate that corresponds to an intersecting portion between the first and second detection electrode patterns. The insulator has a rectangular outer shape as viewed from above (see, for example, Patent Literature 2).

However, in the above input unit, a long-side direction of the insulator and an arrangement direction (e.g., X-direction) of the pixel areas substantially coincide with each other, as viewed from above. Moreover, in the above input unit, a short-side direction of the insulator and an arrangement direction (e.g., Y-direction) of the pixel areas substantially coincide with each other, as viewed from above. The substantial coincidence between the long-side direction and short-side direction of the insulator and respective arrangement directions of the pixel areas generates optical interference between the pixel areas and insulator, causing a problem in that, for example, the insulator is observed as point-like light by a user. This deteriorates visibility of the input unit.

### CITATION LIST

### Patent Literature

Patent Literature 1: Japanese Laid-open Patent Publication No. 2011-13725

Patent Literature 2: Japanese Laid-open Patent Publication No. 2010-140370

### SUMMARY

### Technical Problem

The present invention has been made in view of the above problem, an object thereof is to provide an input unit, an electronic device, and a mobile terminal capable of reducing a possibility of deterioration of visibility.

### Solution to Problem

One aspect of an input unit of the present invention is an input unit disposed opposite to a display unit having a plurality of pixel areas arranged in a matrix, comprising: a substrate; a first detecting electrode pattern provided on the substrate; a second detecting electrode pattern provided on the substrate; and an insulator provided at a portion corresponding to an intersecting portion where the first detecting electrode pattern and second detecting electrode pattern intersect, wherein the insulator has a profile extending in a direction different from arrangement directions of the pixel area as viewed from above.

Another aspect of an input unit of the present invention is an input unit comprising: a substrate having substantially a rectangular outer shape as viewed from above; a first detecting electrode pattern provided on the substrate; a second detecting electrode pattern provided on the substrate; and an insulator provided at a portion corresponding to an intersecting portion where the first detecting electrode pattern and second detecting electrode pattern intersect, wherein the insulator has a profile extending in a long-side direction of the substrate and a short-side direction thereof as viewed from above.

Another aspect of an input unit of the present invention is an input unit comprising: a substrate; a first detecting electrode pattern provided on the substrate and arranged in a first direction; a second detecting electrode pattern provided on the substrate and arranged in a second direction different from the first direction; and an insulator provided at a portion corresponding to an intersecting portion where the first detecting electrode pattern and second detecting electrode pattern intersect, wherein the insulator has a profile extending in the first direction and second direction as viewed from above.

One aspect of an electronic device of the present invention is an electronic device comprising: the input unit of the present invention; and a display unit disposed opposite to the input unit.

One aspect of a mobile terminal of the present invention is a mobile terminal comprising the electronic device of the present invention.

### BRIEF DESCRIPTION OF DRAWINGS

FIG. 1 is a cross-sectional view illustrating a schematic configuration of an electronic apparatus according to an embodiment of the present invention.

FIG. 2 is an exemplary plan view illustrating a plurality of pixel areas that a crystal liquid panel has.

FIG. 3 is a plan view illustrating a schematic configuration of an input unit according to the present embodiment.

FIG. 4 is a cross-sectional view taken along a cut line I-I of FIG. 3.

FIG. 5 is a cross-sectional view taken along a cut line II-II of FIG. 3.

FIG. 6 is a plan view illustrating, in an enlarged manner, a portion K2 of FIG. 3, and FIG. 6 illustrates a case where an insulator has a circular outer shape as viewed from above.

FIG. 7 is a plan view illustrating, in an enlarged manner, a portion K2 of FIG. 3, and FIG. 7 illustrates a case where the insulator has an ellipsoidal outer shape as viewed from above.

FIG. 8 is a perspective view illustrating a schematic configuration of a mobile terminal according to the present embodiment.

FIG. 9 is a plan view illustrating a schematic configuration of an input unit according to Modification 1.

FIG. 10 is a plan view illustrating, in an enlarged manner, a portion K2 of FIG. 9.

FIG. 11 is a plan view illustrating a schematic configuration of an input unit according to Modification 2.

FIG. 12 is a cross-sectional view taken along a cut line III-III of FIG. 11.

FIG. 13 is a cross-sectional view taken along a cut line IV-IV of FIG. 11.

### DESCRIPTION OF EMBODIMENTS

An embodiment of the present invention will be described with reference to the drawings.

However, the drawings to be referred to below schematically illustrate only main components of an embodiment of the present invention for descriptive convenience. Thus, an input unit, an electronic device, and a mobile terminal each can include any component not illustrated in the drawings referred to in this specification.

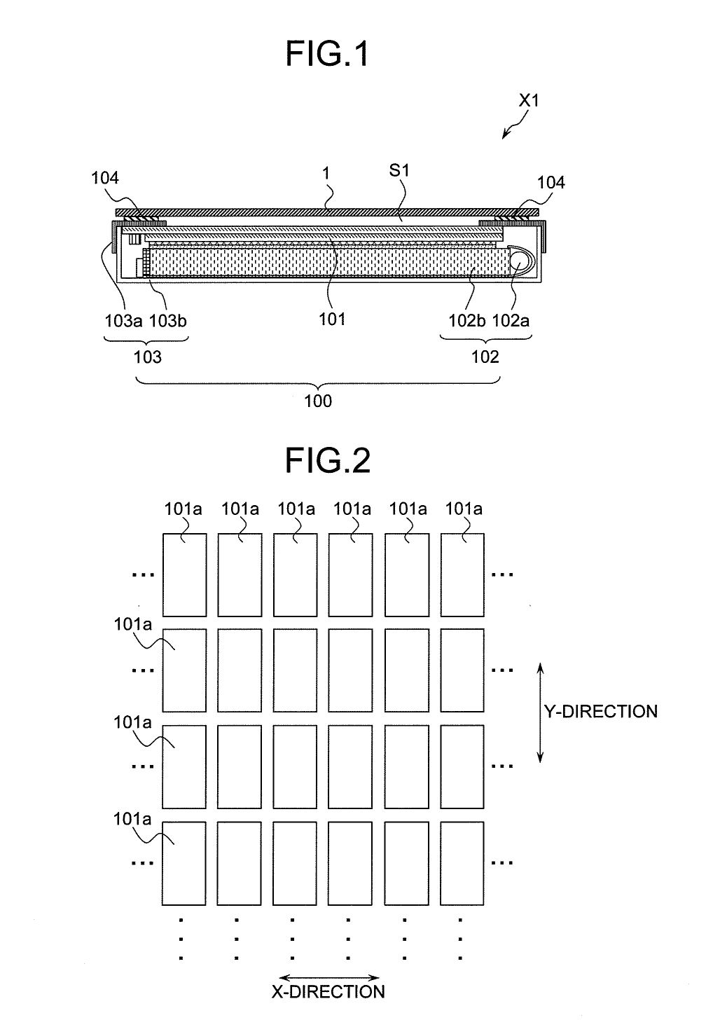

As illustrated in FIG. 1, an electronic device X1 according to the present embodiment includes an input unit 1 and a display unit 100 disposed opposite to the input unit 1.

First, before description of the input unit 1, the display unit 100 will be described.

The display unit 100 according to the present embodiment includes a liquid crystal panel 101, a backlight 102, and a first casing 103.

The liquid crystal panel 101 is a display panel that utilizes a liquid crystal composition for display. Specifically, the liquid crystal panel 101 includes an upper substrate, a lower substrate disposed opposite to the upper substrate, a liquid crystal layer interposed between the upper and lower substrates, and a display material layer interposed between the upper and lower substrates and contributing to display. For example, the display material layer includes a pixel electrode, an oriented film, and a color filter. The liquid crystal panel 101 may be an active matrix driven type or a simple matrix driven type. The liquid crystal panel 101 may be a monochrome display type or a color display panel.

As illustrated in FIG. 2, the liquid crystal panel 101 has a plurality of pixel areas 101a arranged in a matrix. Specifically, the pixel areas 101a are arranged in an X-direction and in a Y-direction perpendicular to the X-direction. That is, in the present embodiment, arrangement directions of the pixel areas 101a represent the X-direction and Y-direction. The “X-direction” is an embodiment of a “first direction” according to the present invention. The “Y- direction” is an embodiment of a “second direction” according to the present invention.

When the liquid crystal panel 101 is the active matrix driven type, each pixel area 101a is surrounded by a gate wiring and a data wiring and has therein a pixel electrode. That is, each pixel area 101a corresponds to one pixel. The one pixel may represent a pixel corresponding to one of three colors: red, green, and blue, included in a color filter or may represent a pixel corresponding to a set of three colors: red, green, and blue, included in a color filter. When the one pixel represents a pixel corresponding to one of three colors: red, green, and blue, included in a color filter, a not illustrated black matrix is disposed between the pixel areas 101a.

The liquid crystal panel 101 may be replaced with a display panel such as a plasma panel, an organic EL panel, or an electronic paper. The organic EL panel is a display panel using a substance that emits light when voltage is applied thereto. Specifically, in the organic EL panel, a luminous body using an organic matter such as diamine is deposited on a substrate, and 5 V to 10 V DC voltage is applied to the resultant substrate, whereby display is achieved. When the organic EL panel is used in place of the liquid crystal panel 101, the backlight 102 to be described below is unnecessary.

The backlight 102 includes a light source 102a and a light guide plate 102b. The light source 102a is a member playing a role of emitting light toward the light guide plate 102b and is, e.g., an LED (Light Emitting Diode). The LED may be replaced with a cold cathode fluorescent lamp, a halogen lamp, a xenon lamp, or an EL (Electro-Luminescence). The light guide plate 102b is a member playing a role of guiding the light from the light source 102a substantially uniformly over the entire lower surface of the liquid crystal panel 101.

The first casing 103 has a role of housing the liquid crystal panel 101 and backlight 102 and includes an upper-side casing 103a and a lower-side casing 103b. For example, as a material for forming the first casing 103, a resin such as polycarbonate or metal such as stainless or aluminum can be used.

The display unit 100 is connected to the input unit 1 through a double-sided tape 104. The double-sided tape 104 may be replaced with an adhesive material such as a thermoset resin or an ultraviolet curing resin. In the present embodiment, the input unit 1 and display unit 100 are disposed opposite to each other through a space S1.

The following describes the input unit 1.

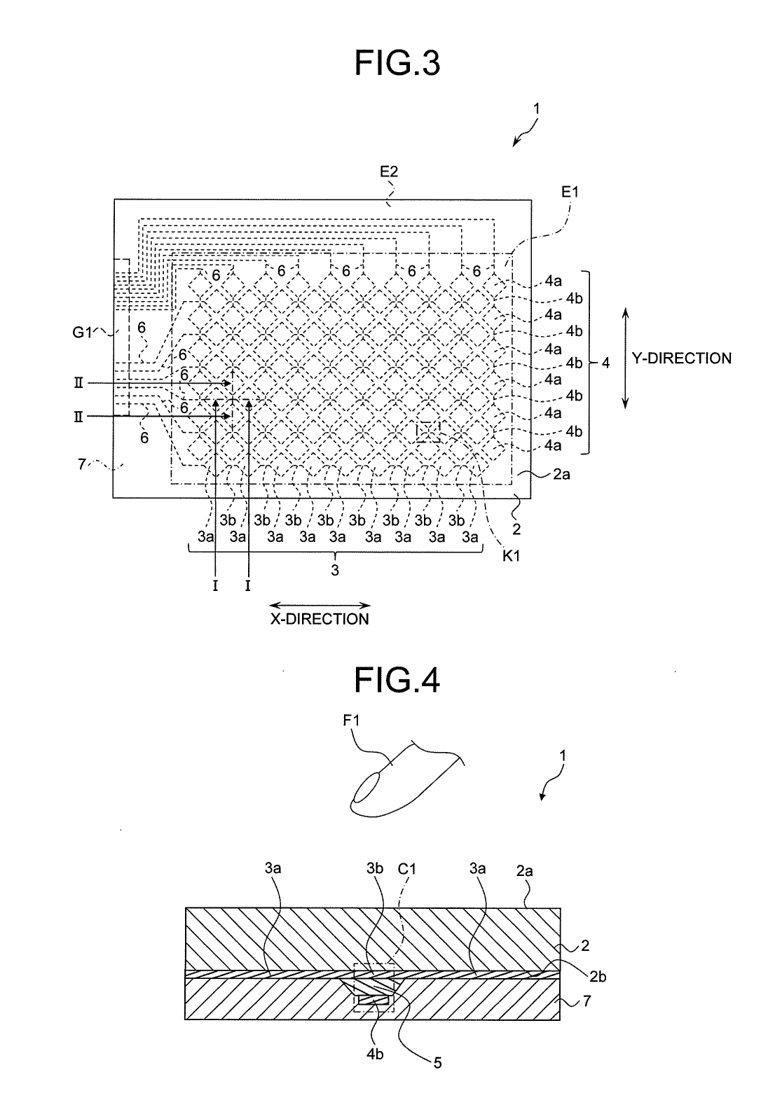

As illustrated in FIG. 3, the input unit 1 according to the present embodiment is an electrostatic capacitance touch panel and includes an input area El and a non-input area E2. The input area E1 is an area on which a user can perform input operation. The non-input area E2 is an area on which a user cannot perform input operation. The non-input area E2 according to the present embodiment is positioned outside the input area E1 so as to surround the input area E1, but the arrangement position of the non-input area E2 is not limited thereto. For example, the non-input area E2 may be positioned within the input area E1.

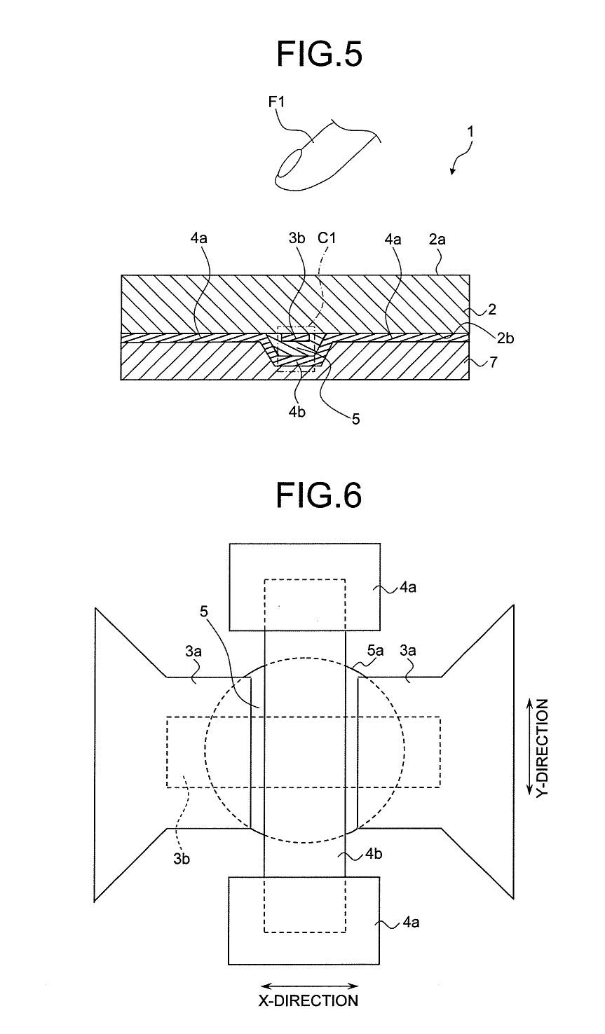

As illustrated in FIGS. 3 to 5, the input unit 1 has a substrate 2.

The substrate 2 has a role of supporting a first detecting electrode pattern 3, a second detecting electrode pattern 4, an insulator 5, a detecting wiring 6, and a protective layer 7. The substrate 2 has a first main surface 2a and a second main surface 2b positioned on a side opposite to the first main surface 2a. The first main surface 2a of the substrate 2 is a surface that a user directly touches for input operation. In order to reduce a possibility that the first main surface 2a of the substrate 2 is scratched up, a protective sheet for protecting the first main surface 2a of the substrate 2 may be provided on the first main surface 2a of the substrate 2.

The substrate 2 has substantially a rectangular outer shape as viewed from above. In the present embodiment, the substrate 2 has two opposing long sides and two opposing short sides. In the present embodiment, a long-side direction extending along the long side of the substrate 2 coincides with the X-direction, and a short-side direction extending along the short side of the substrate 2 coincides with the Y-direction. In this specification, “substantially rectangular” is a concept including a shape in which a corner portion of the substrate 2 is rounded. Moreover, in this specification, “substantially” represents the same meaning as practically.

The substrate 2 has an insulating property and has translucency with respect to light incident thereto in a direction intersecting the first and second main surfaces 2a and 2b of the substrate 2. In this specification, “translucency” represents light permeability with respect to visible light. For example, as a material for forming the substrate 2, a glass or a plastic can be used. When a glass is used to form the substrate 2, a glass chemically strengthened by ion-exchange is preferably used for enhancement of strength.

On the second main surface 2b of the substrate 2 corresponding to the input area El, a first detecting electrode pattern 3 and a second detecting electrode pattern 4 are provided.

The first detecting electrode pattern 3 has a role of generating an electrostatic capacitance between itself and a user's finger F1 coming close to the first main surface 2a of the substrate 2 corresponding to the input area E1 to detect an input position in the Y-direction. The first detecting electrode pattern 3 is arranged in plural number in the X-direction on the second main surface 2b of the substrate 2 corresponding to the input area E1. The first detecting electrode pattern 3 includes first detecting electrodes 3a and first inter-electrode wirings 3b.

The first detecting electrode 3a has a role of generating an electrostatic capacitance between itself and the user's finger F1. The first detecting electrode 3a is arranged in plural number in the X-direction. The first inter-electrode wiring 3b has a role of electrically connecting the first detecting electrodes 3a. The first inter-electrode wiring 3b is provided between the first detecting electrodes 3a which are adjacent to each other.

The second detecting electrode pattern 4 has a role of generating an electrostatic capacitance between itself and the user's finger F1 coming close to the first main surface 2a of the substrate 2 corresponding to the input area E1 to detect an input position in the X-direction. The second detecting electrode pattern 4 is arranged in plural number in the Y-direction on the second main surface 2b of the substrate 2 corresponding to the input area E1. Each second detecting electrode pattern 4 includes second detecting electrodes 4a and second inter-electrode wirings 4b.

The second detecting electrode 4a has a role of generating an electrostatic capacitance between itself and the user's finger F1. The second detecting electrode 4a is arranged in plural number in the Y-direction. The second inter-electrode wiring 4b has a role of electrically connecting the second detecting electrodes 4a. The second inter-electrode wiring 4b is provided between the second detecting electrodes 4a which are adjacent to each other and on the insulator 5 so as to stride over the insulator 5 in such a manner that the second inter-electrode wiring 4b is electrically isolated from the first inter-electrode wiring 3b.

The insulator 5 is provided on the second main surface 2b of the substrate 2 corresponding to an intersecting portion C1 at which the first detecting electrode pattern 3 and second detecting electrode pattern 4. The insulator 5 is provided so as to cover the first inter-electrode wiring 3b. The insulator 5 according to the present embodiment is formed so as to become smaller in diameter from the second main surface 2b of the substrate 2 toward the protective layer 7. An outer shape of the insulator 5 as viewed from above will be described later. For example, as a material for forming the insulator 5, a transparent resin such as an acrylic resin, an epoxy resin, a silicon resin, a silicon dioxide resin, or a silicon nitride resin can be used.

The first detecting electrode 3a and second detecting electrode 4a each has substantially a rhombic shape as viewed from above, but the shape thereof is not limited to the rhombic shape, and may be, e.g., a polygonal shape or a circular shape. Forming the first detecting electrode 3a and second detecting electrode 4a into substantially the rhombic shape as viewed from above can make a gap between the first detecting electrode 3a and second detecting electrode 4a small. This can relatively increase areas of the first detecting electrode 3a and second detecting electrode 4a which are provided on the second main surface 2b of the substrate 2. As a result, it is possible to increase the electrostatic capacitance to be generated between the first and second detecting electrodes 3a, 4a and the finger F1, thereby increasing detection sensitivity of the input unit 1.

For example, as a material for forming the first detecting electrode pattern 3 and second detecting electrode pattern 4, a conductive material having translucency can be used. Examples of the conductive material having translucency include ITO (Indium Tin Oxide), IZO (Indium Zinc Oxide), ATO (Al-doped Zinc Oxide), tin oxide, zinc oxide, and conductive high molecule.

A formation method of the first detecting electrode pattern 3 and second detecting electrode pattern 4 is as follows. For example, the above-mentioned material is formed into a film on the second main surface 2b of the substrate 2 using a sputtering method, an evaporation method, or a CVD (Chemical Vapor Deposition) method. Subsequently, a photosensitive resin is coated on a surface of the formed film, followed by exposure, development, and etching, to pattern the film, thereby forming the first detecting electrode pattern 3 and second detecting electrode pattern 4.

FIG. 6 is a plan view illustrating a portion K1 of FIG. 3 in an enlarged manner. As illustrated in FIG. 6, the insulator 5 has a profile 5a extending in a different direction from the arrangement directions of the pixel area 101a. In other words, as viewed from above, the profile 5a of the insulator 5 extends in a different direction from the long-side direction of the substrate 2 and the short-side direction of the substrate 2. In still other words, as viewed from above, the profile 5a of the insulator 5 extends in a different direction from the X-direction and Y-direction. Specifically, as viewed from above, the profile 5a of the insulator 5 assumes a closed curve. The closed curve means a continuous curve having no end points. In the present embodiment, as viewed from above, the insulator 5 has a circular outer shape.

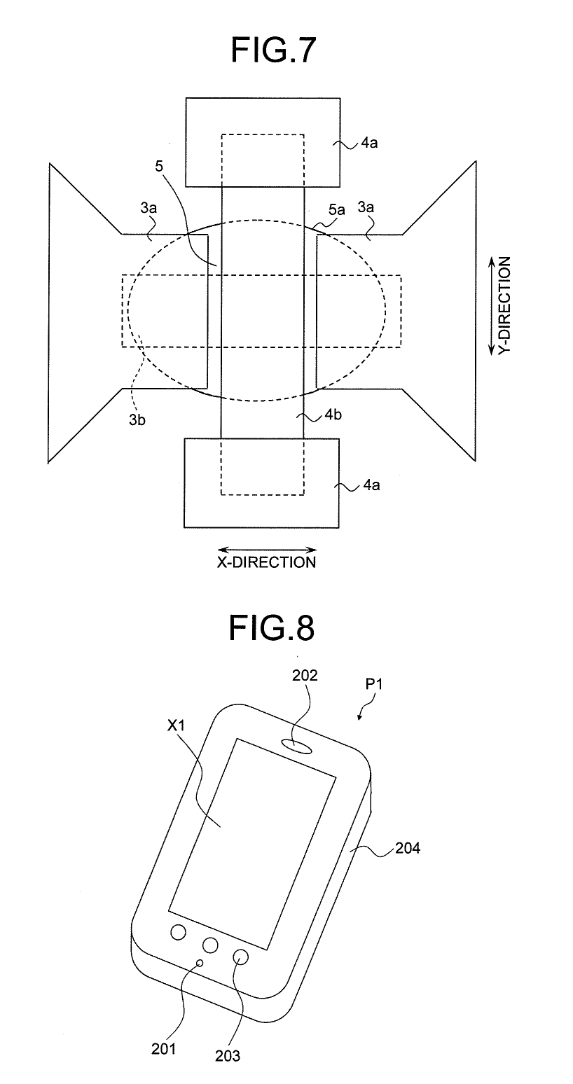

The profile 5a of the insulator 5 extends in a different direction from the arrangement directions of the pixel area 101a as viewed from above, so that a possibility of occurrence of optical interference between the pixel area 101a and insulator 5 can be reduced. This is because the arrangement directions of the profile 5a of the insulator 5 and the pixel area 101a do not coincide with each other as viewed from above. Thus, in the input unit 1, a possibility of occurrence a problem in that, for example, the insulator 5 is observed as point-like light by a user is reduced. This can reduce deterioration of visibility of the input unit 1. The insulator 5 may have an ellipsoidal outer shape as viewed from above as illustrated in FIG. 7. Although the insulator 5 has an ellipsoidal outer shape elongated along the first detecting electrode pattern 3 in FIG. 7, it may have an ellipsoidal outer shape elongated along the second detecting electrode pattern 4.

In a case where the insulator 5 has a circular outer shape as viewed from above as in the present embodiment, it is possible to alleviate a stress to be applied to the insulator 5 due to a user's input operation, etc., with respect to the first main surface 2a of the substrate 2 as compared with a case where the insulator 5 has a rectangular outer shape as viewed from above. This can reduce a possibility that the insulator 5 is peeled off from the second main surface 2b of the substrate 2. The same effect can be obtained in a case where the insulator 5 has an ellipsoidal outer shape as viewed from above. That is, when a part of the profile 5a of the insulator 5 assumes a curve as viewed from above, the stress to be applied to the insulator 5 can be alleviated to some extent.

On the second main surface 2b of the substrate 2 corresponding to the non-input area E2, a detecting wiring 6 is provided.

The detecting wiring 6 has a role of applying current to the first detecting electrode pattern 3 and second detecting electrode pattern 4 and a role of detecting a change in an electrostatic capacitance generated between the first and second detecting electrode patterns 3, 4 and the finger F1. In the present embodiment, the detecting wiring 6 is provided in plural number in the non-input area E2 positioned on one long-side side of the substrate 2 and in the non-input area E2 positioned on one short-side side of the substrate 2, respectively. One end portion of the detecting wiring 6 is electrically connected to the first detecting electrode pattern 3 and second detecting electrode pattern 4, and the other end thereof is positioned in an external conducting area Gl. The external conducting area G1 is connected to a not illustrated flexible substrate. The flexible substrate has thereon, e.g., a position detecting driver to be described later.

The detecting wiring 6 is formed of a metal thin film for obtaining high hardness and high shape stability. Examples of the metal thin film include an aluminum film, an aluminum alloy film, a laminated film of a chromium film and an aluminum film, a laminated film of a chromium film and an aluminum alloy film, a silver film, a silver alloy film, and a gold alloy film. For example, as a method for forming the metal thin film, a sputtering method, a CVD method, or an evaporation method can be used.

On the second main surface 2b of the substrate 2 corresponding to both the input area El and non-input area E2, a protective layer 7 is provided.

The protective layer 7 has a role of protecting the first detecting electrode pattern 3, second detecting electrode pattern 4, and detecting wiring 6. The role of protecting the first detecting electrode pattern 3, second detecting electrode pattern 4, and detecting wiring 6 includes, e.g., a role of protecting the first and second detecting electrode patterns 3, 4 and detecting wiring 6 from being scratched due to external impact and a role of protecting the first and second detecting electrode patterns 3, 4 and detecting wiring 6 from becoming eroded due to moisture adsorption. For example, as a material for forming the protective layer 7, an acrylic-based resin, a silicon-based resin, a rubber-based resin, an urethane-based resin, silicon dioxide, and silicon nitride. For example, as a method for forming the protective layer 7, a sputtering method, a transfer printing method, a spin coating method, and a slit coating method.

The following describes a detection principle of the input unit 1.

The not illustrated position detecting driver is electrically connected to the detecting wiring 6 positioned in the external conducting area G1. The position detecting driver has a power supply unit. The power supply unit of the position detecting driver supplies voltage to the first detecting electrode pattern 3 and second detecting electrode pattern 4. When the finger F1 as a conductive body comes close to the first main surface 2a of the substrate 2 corresponding to the input area E1, an electrostatic capacitance is generated between the finger F1 and first and second detecting electrode patterns 3, 4. The position detecting driver always detects the electrostatic capacitance generated in the first detecting electrode pattern 3 and second detecting electrode pattern 4 and identifies an input position at which a user performs input operation by a combination of the first detecting electrode pattern 3 and second detecting electrode pattern 4 from which an electrostatic capacitance equal to or larger than a predetermined value. In this manner, the input unit 1 detects the input position.

The input unit 1 operates the input area E1 while seeing through the liquid crystal panel 101 of the display unit 100 to thereby input various information. A function that gives a user who is performing input operation of various information various tactile sensations, such as pressing sensation, tracing sensation, and touching sensation, may be added to the input unit 1. In this case, one or more vibrating bodies (e.g., piezoelectric elements) are provided in the substrate 2 of the input unit 1, the vibrating bodies being vibrated in a predetermined frequency when the input unit 1 detects predetermined input operation or predetermined pressing load.

As described above, the input unit 1 can reduce a possibility of deterioration of visibility. Moreover, the electronic device X1 including the input unit 1 can also reduce a possibility of the visibility degradation.

The following describes a mobile terminal P1 including the above electronic device X1 with reference to FIG. 8.

FIG. 8 is a perspective view illustrating a schematic configuration of the mobile terminal P1 according to the present embodiment. As illustrated in FIG. 8, the mobile terminal P1 is, e.g., a mobile phone, a smartphone, a PDA (Personal Digital Assistant), or the like and includes the electronic device X1, a voice input section 201, a voice output section 202, a key input section 203, and a second casing 204.

The voice input section 201 is realized by, e.g., a microphone and receives as an input voice of a user. The voice output section 202 is realized by, e.g., a speaker and outputs voice from a communication partner. The key input section 203 is realized by, e.g., mechanical keys. The key input section 203 may be operation keys displayed on a display screen. The second casing 204 is a member having a role of housing the electronic device X1, the voice input section 201, the voice output section 202, and the key input section 203.

Although the mobile terminal P1 may further include a digital camera section, a One-Seg broadcast tuner, a near-field communication section such as an infrared communication section, and various interfaces, detailed illustration and description thereof are omitted.

The mobile terminal P1 includes the electronic device X1 and can thus reduce a possibility of the visibility degradation.

Although the mobile terminal P1 includes the voice input section 201, the configuration thereof is not limited to this. That is, the mobile terminal P1 need not always be provided with the voice input section 201.

Moreover, the mobile terminal P1 includes the second casing 204 that houses the electronic device X1, the configuration thereof is not limited to this. That is, the mobile terminal P1 need not always be provided with the second casing 204 independently, but the first casing 103 of the electronic device X1 may be used as the casing of the mobile terminal P1.

The above embodiment illustrates a concrete example of the embodiment of the present invention and may be modified variously. The following describes some main modifications.

[Modification 1]

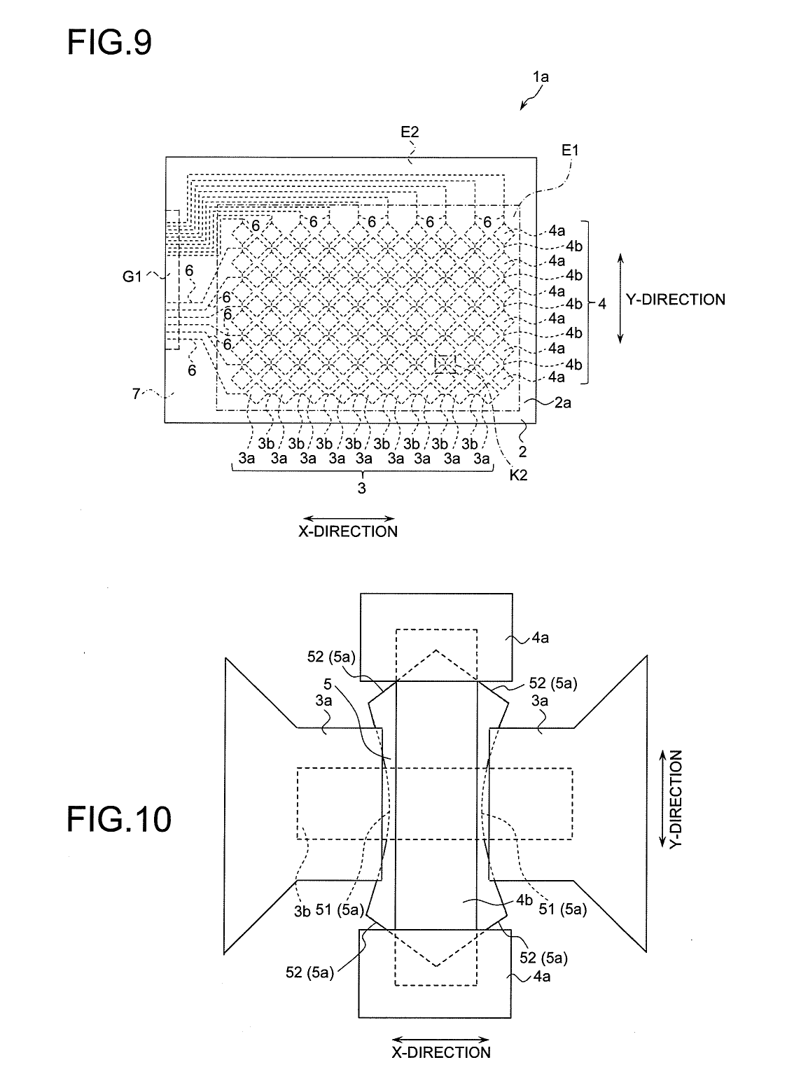

FIG. 9 is a plan view illustrating a schematic configuration of an input unit 1a according to Modification 1. FIG. 10 is a plan view illustrating, in an enlarged manner, a portion K2 of FIG. 9. In FIGS. 9 and 10, the same reference numerals are given to the components having the same functions as those illustrated in FIGS. 3 and 6, and the detailed descriptions thereof will be omitted.

As illustrated in FIG. 10, in the input unit 1a, a part 51 of a profile 5a of an insulator 5 assumes a curve as viewed from above. Moreover, in the input unit 1a, a residual part 52 of the profile 5a of the insulator 5 assumes a straight line extending along a direction different from arrangement directions of a pixel area 101a, as viewed from above. In other words, as viewed from above, the residual part 52 of the profile 5a of the insulator 5 assumes a straight line extending along a direction different from a long-side direction of a substrate 2 and a short-side direction of the substrate 2. Still in other words, as viewed from above, the residual part 52 of the profile 5a of the insulator 5 assumes a straight line extending in a direction different from the X-direction and Y-direction. In Modification 1, as viewed from above, the insulator 5 has an outer shape such that both end portions in the X-direction are concaved and both end portions in the Y-direction are convexed.

As described above, as in the input unit 1, in the input unit 1a, the part 51 and residual part 52 of the profile 5a of the insulator 5 are each formed along a direction different from the arrangement directions of the pixel area 101a as viewed from above, so that a possibility of occurrence of optical interference between the pixel area 101a and insulator 5 can be reduced. This is because the arrangement directions of the part 51 and residual part 52 of the profile 5a of the insulator 5 and the arrangement directions of the pixel area 101a do not coincide with each other as viewed from above. Thus, in the input unit 1a, a possibility of generating a problem in that, for example, the insulator 5 is observed as point-like light by a user is reduced. This can reduce deterioration of visibility of the input unit 1a.

Moreover, in the input unit 1a, the part 51 of the profile 5a of the insulator 5 assumes a curve, so that it is possible to alleviate a stress to be applied to the insulator 5 due to a user's input operation, etc., with respect to a first main surface 2a of the substrate 2. This can reduce a possibility that the insulator 5 is peeled off from a second main surface 2b of the substrate 2.

Moreover, in the input unit 1a, as viewed from above, the insulator 5 has an outer shape such that both end portions in the X-direction are concaved and both end portions in the Y-direction are convexed, so that it is possible to reduce an area of the insulator 5 as viewed from above as compared to a case where the insulator has an outer circular shape or outer ellipsoidal shape as viewed from above. As a result, in the input unit 1a, it is possible to further reduce a possibility that the insulator 5 is visually perceived by a user.

It is preferable to set an angle between a straight line of the residual part 52 of the profile 5a of the insulator 5 and each of the arrangement angles of the pixel area 101a to 30° or larger so as to reduce a possibility of occurrence of optical interference. That is, when the straight line of the residual part 52 of the profile 5a of the insulator 5 is inclined by 30° or larger relative to each of the arrangement directions of the pixel area 101a, a possibility of occurrence of optical interference between the pixel area 101a and insulator 5 can be reduced.

Although the residual part 52 of the profile 5a of the insulator 5 assumes a straight line extending in a direction different from the arrangement directions of the pixel area 101a as viewed from above, the configuration thereof is not limited to this. The residual part 52 of the profile 5a of the insulator 5 may assume a curve as viewed from above.

[Modification 2]

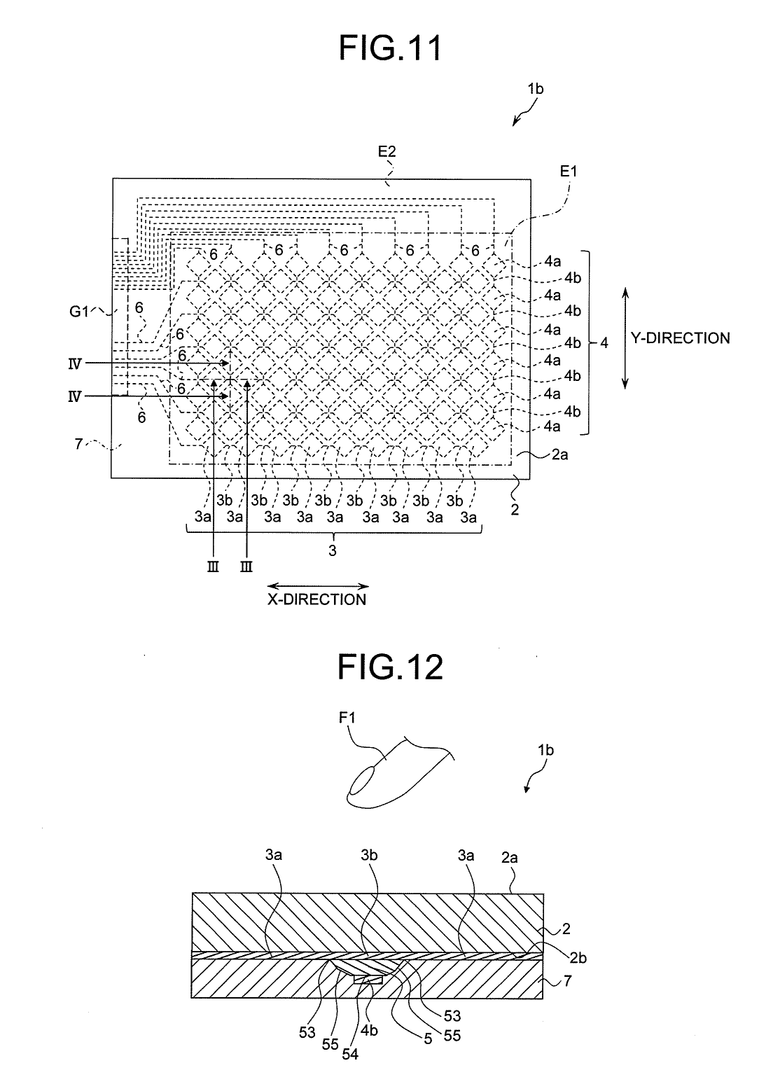

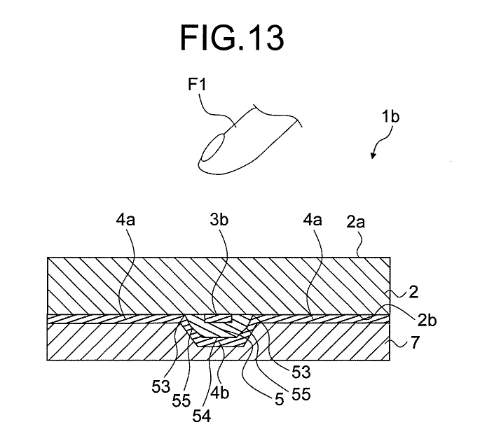

FIG. 11 is a plan view illustrating a schematic configuration of an input unit lb according to Modification 2. FIG. 12 is a cross-sectional view taken along a cut line III-III of FIG. 11. FIG. 13 is a cross-sectional view taken along a cut line IV-IV of FIG. 11. In FIGS. 11 to 13, the same reference numerals are given to the components having the same functions as those illustrated in FIGS. 3 to 5, and the detailed descriptions thereof will be omitted.

As illustrated in FIGS. 12 and 13, in the input unit 1b, an insulator 5 has a convex curved surface 55 in an area from an edge portion 53 to a top portion 54. The insulator has the convex curved surface 55, so that it is possible to further reduce a possibility that the insulator 5 is visually perceived by a user as compared with a case where an outer shape of the insulator 5 is a rectangular in cross sectional view. This is because, in the input unit 1b, an area from the edge portion 53 to the top portion 54 is formed into a gentle slope.

Moreover, the insulator 5 has the convex curved surface 55, so that it is possible to alleviate a stress to be applied to the insulator 5 due to a user's input operation, etc., with respect to a first main surface 2a of a substrate 2. This can reduce a possibility that the insulator 5 is peeled off from a second main surface 2b of the substrate 2.

It is preferable to set an angle between the second main surface 2b of the substrate 2 and insulator 5 to a range of 2° to 20° so as to reduce the possibility that the insulator 5 is visually perceived by a user and to alleviate the stress to be applied to the insulator 5.

[Modification 3]

Although the input operation is performed with respect to the first main surface 2a of the substrate 2 in the above description, the configuration is not limited to this. For example, the input operation may be performed with respect to the second main surface 2b of the substrate 2. In this case, an additional protective sheet formed of a glass or plastic needs to be provided on the protective layer 7.

Moreover, although the input unit 1, 1a, or 1b and the display unit 100 are separately provided in the above description, the configuration is not limited to this. For example, the first detecting electrode pattern 3 and second detecting electrode pattern 4 of the input unit 1, 1a, or 1b may be provided on an upper substrate of the liquid crystal panel 101 constituting the display unit 100. In this case, the upper substrate of the liquid crystal panel 101 can be used also as the substrate of the input unit 1, 1a, or 1b, so that it is possible to reduce a thickness of the electronic device X1. That is, the present invention can be applied to an on-cell technology.

Moreover, the input unit 1, 1a, or 1b is embodied as an electrostatic capacitance touch panel, but not limited thereto. That is, the present invention can be applied to a touch panel of any other type as long as it includes the insulator provided on the substrate corresponding to the intersecting portion between the first and second detection electrode patterns.

[Modification 4]

The input unit 1a or 1b may be mounted to the electronic device X1 in place of the input unit 1, and the electronic device X1 having the input unit 1a or 1b may be mounted to the mobile terminal P1. Moreover, the configurations of the input units 1, 1a, and 1b may be combined appropriately.

### REFERENCE SIGNS LIST

X1 Electronic device

P1 Mobile terminal

1, 1a, 1b Input unit

2 Substrate

3 First detecting electrode pattern

4 Second detecting electrode pattern

5 Insulator

5a Profile of insulator

51 Part of profile of insulator

52 Residual part of profile of insulator

53 Edge portion of insulator

54 Top portion of insulator

55 Convex curved surface of insulator

100 Display unit

101a Pixel electrode

C1 Intersecting portion

1. An input unit disposed opposite to a display unit having a plurality of pixel areas arranged in a matrix, comprising:
a substrate;
a first detecting electrode pattern provided on the substrate;
a second detecting electrode pattern provided on the substrate; and
an insulator provided at a portion corresponding to an intersecting portion where the first detecting electrode pattern and second detecting electrode pattern intersect,
wherein the insulator has a profile extending in a direction different from arrangement directions of the pixel area as viewed from above.

2. The input unit according to claim 1, wherein the profile of the insulator assumes a closed curve as viewed from above.

3. The input unit according to claim 2, wherein the insulator has a circular outer shape or an ellipsoidal outer shape.

4. The input unit according to claim 1, wherein a part of the profile of the insulator assumes a curve as viewed from above, and
a residual part of the profile of the insulator assumes a straight line extending along a direction different from the arrangement directions of the pixel area as viewed from above.

5. The input unit according to claim 1, wherein the insulator has a convex curved surface in an area from an edge portion of the insulator to a top portion thereof.

6. An input unit comprising:
a substrate having substantially a rectangular outer shape as viewed from above;
a first detecting electrode pattern provided on the substrate;
a second detecting electrode pattern provided on the substrate; and
an insulator provided at a portion corresponding to an intersecting portion where the first detecting electrode pattern and second detecting electrode pattern intersect,
wherein the insulator has a profile extending in a long-side direction of the substrate and a short-side direction thereof as viewed from above.

7. An input unit comprising:
a substrate;
a first detecting electrode pattern provided on the substrate and arranged in a first direction;
a second detecting electrode pattern provided on the substrate and arranged in a second direction different from the first direction; and
an insulator provided at a portion corresponding to an intersecting portion where the first detecting electrode pattern and second detecting electrode pattern intersect,
wherein the insulator has a profile extending in the first direction and second direction as viewed from above.

8. An electronic device comprising:
the input unit according to claim 1; and
a display unit disposed opposite to the input unit.

9. A mobile terminal comprising the electronic device according to claim 8.

10. An electronic device comprising:
the input unit according to claim 6; and
a display unit disposed opposite to the input unit.

11. A mobile terminal comprising the electronic device according to claim 10.

12. An electronic device comprising:
the input unit according to claim 7; and
a display unit disposed opposite to the input unit.

13. A mobile terminal comprising the electronic device according to claim 12.
